(19) United States
(12) Patent Application Publication
(10) Pub. No.: US 2015/0090092 A1
(43) Pub. Date: Apr. 2, 2015

(54) DOUBLE-BOLT UNIT INCLUDING SLIP DISK AND APPLICATION THEREOF

(71) Applicant: Hirofumi Saito, Chula Vista, CA (US)

(72) Inventor: Hirofumi Saito, Chula Vista, CA (US)

(21) Appl. No.: 14/043,503

(22) Filed: Oct. 1, 2013

(51) Int. Cl. B26F 1/14; B21D 28/34

(52) U.S. Cl. CPC B26F 1/14; B21D 28/34
USPC 83/686; 83/698.91

(57) ABSTRACT

A double-bolt unit is provided, including a first bolt, a second bolt, and a slip disk haying substantially a disk shape, the slip disk placed on top of the first bolt and below the second bolt and concentrically with the first bolt and the second bolt around a cylindrical axis. The slip disk is configured to contact a portion of the first bolt and a portion of the second bolt, wherein a first radius from the cylindrical axis to the portion of the first bolt in contact with the slip disk is larger than a second radius from the cylindrical axis to the portion of the second bolt in contact with the slip disk. A punching tool including, the double-bolt unit is provided, wherein the slip disk prevents lowering of the first bolt below a predetermined position, thereby preventing a portion of a punch holder layer from bulging to bold the punch too tightly.

### BACKGROUND

A press die set is used to create a hole in a work piece such as a metal plate. This is accomplished by punching the work piece with a punching tool incorporated in the press die set. Multiple parts are put together to construct the punching tool to achieve effective punching action. The punching action can be repeated with fast speed to punch holes in multiple Work pieces. Maintenance and or replacement of parts are often necessary for the continual optimum performance of such machinery. The main part of the punching tool is a punch itself coupled to various supporting parts. However, the punch may be trapped or held too tightly due to shifting or displacement of the surrounding parts, thereby making it difficult to access and/or replace the punch during maintenance or when needed.

### BRIEF DESCRIPTION OF THE DRAWINGS

FIG. 1 illustrates an example of a conventional press die set.

FIG. 2 illustrates a conventional double-bolt structure, showing the top view and the vertical cross-sectional view.

FIG. 3 illustrates an expanded view of a part of the press die set of FIG. 1.

FIG. 4 illustrates an example of a slip disk that can be included in the double-bolt unit, showing the top view and the side view.

FIG. 5 illustrates an example of a bolt that can be included in the double-bolt unit, showing the top view and the side view.

FIG. 6 illustrates a double-bolt unit according to an embodiment, showing the top view and the vertical cross-sectional view.

FIG. 7 illustrates an expanded side view of the double-bolt unit of FIG. 6.

FIG. 8 illustrates a press die set in which the punching tool is configured to include the double-bolt unit having a slip disk.

FIG. 9 illustrates examples of shapes of the slip disk.

### DETAILED DESCRIPTION

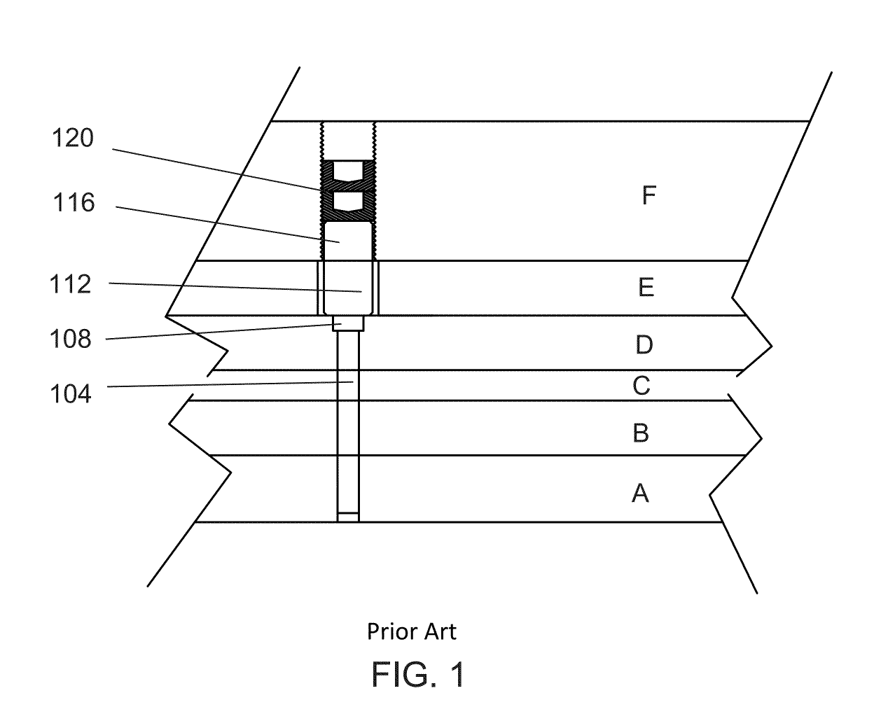

FIG. 1 illustrates an example of a conventional press die set. The cross-sectional view of the main operational section is illustrated schematically in this figure. The press the set includes layers A-F in this example. A punching tool is vertically provided through the layers, the punching tool including multiple parts 104-120 in this example. A punch 104 is used to punch a hole in a workpiece such as a metal sheet. The work piece subject to punching is placed below the layer A. The layer A is used as a stripper to remove the work piece through which the hole has been just created. The layer B is used as a backing to reinforce the stripper, i.e., the layer A, where the thickness of each of layers A and B may be about 1.5-2 cm, for example. The punch 104 is configured to penetrate through the layers A and B. where the gap width between the punch 104 and the inner surface of the penetration hole in the layers A and B may be set to be very small, for example, about 0.001 mm clearance, indicated as the layer C, is formed above the layer B. The punch 104 includes a head 108 formed around the top, the head 108 configured for attachment to a conrod 112, which is a connecting rod for transmitting motion or power from one part to another. The upper portion of the punch 104 including the head 108 is secured in the layer D, which serves as a punch holder. The thickness of the punch holder, i.e., the layer D, may be about 2 cm, for example. The gap width between the punch 104 including the head 108 and the inner surface of the holding hole in the layer D may be set to be small, for example, about 0.005 mm The conrod 112 is placed vertically through a hole formed in the liner E, which serves as a backing to reinforce the punch holder, i.e., the layer D. The gap width between the conrod 112 and the inner surface of the hole formed in the layer F may be about 0.5 mm for example, for adjustment and replacement of the conrod 112. The thickness of each of layers D and E may be about 2 cm, for example. The conrod 112 is coupled to a spacer 116, which is secured by a double bolt 120, which has two bolt stacked vertically. The bottom bolt is used to fix the position of the spacer 116, and the top bolt is used to fix the position of the bottom bolt. The spacer 116 and the double bolt 120 are fixed vertically through the layer F, which serves as a die set plate.

Using the press die set as illustrated in FIG. 1, a bole is created in a work piece placed below the layer A. This is accomplished by vertically lowering the section including the layers D-F together with the punching, tool having multiple parts 104-120 by the height determined by the thickness of the clearance, the layer C. The punch 104 moves through the layers A and B to act on the work piece placed below the layer A, thereby creating a hole in the work piece by the punching action. The resultant work piece is removed promptly by the stripping operation of the stripper and its backing, i.e., the layer A and B. By virtue of a spring action generated by a spring (not shown) connecting the holder backing, i.e., the layer E, and the stripper backing, i.e., the layer B, the lowered section is configured to spring back to the original position, and the clearance, i.e., the layer C, is reassumed. This vertical motion can be repeated with fast speed to punch holes in multiple work pieces.

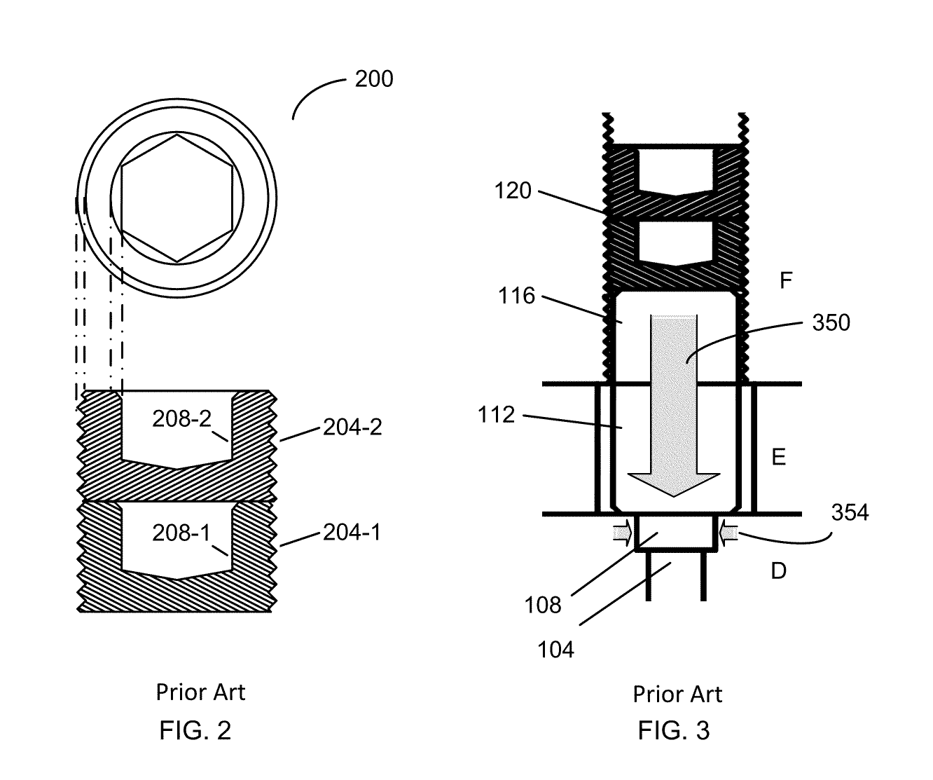

However, there is a problem associated with the conventional punching tool due to the use of the conventional double-bolt structure 120. The root cause of the problem is explained in detail below with reference to FIGS. 2 and 3. FIG. 2 illustrates a conventional double-bolt structure 200, showing the top view and the vertical cross-sectional view. The bolt in this structure may be a set screw having an external thread and an internal socket for wrenching drive. Correspondence between each element in the top view and in the vertical cross-sectional view is indicated by dash-dot line in this figure. The double-bolt structure 200 has a first bolt 204-1 at the bottom and a second bolt 204-2 on top of and in contact with the first bolt 204-1, The horizontal cross-sectional shape of the internal side surface 208-1 of the first bolt 204-1 is hexagonal in this example; however, a shape of a star, a square, a rectangle or other polygonal shape can be used to form the horizontal cross-sectional shape of the internal side surface 208-1. Similarly, a shape of a star, a square, a rectangle, a hexagon or other polygonal shape can be used to form the horizontal cross-sectional shape of the internal side surface 208-2 of the second bolt 204-2. The first bolt 204-1 is used to press another part below, such as the spacer 116 of the punching tool. The second bolt 204-2 is placed on top of the first bolt 204-1 to fix the position of the first bolt 204-1, A wrench having a horizontal cross-sectional shape corresponding to the horizontal cross-sectional shape of the internal side surface 208-1 of the first bolt 204-1 is used to turn down the first bolt 204-1 to a first predetermined position to fix the position of the spacer 116. Thereafter, the second bolt 204-2 is placed on top of the first bolt 204-1, and a wrench having a horizontal cross-sectional shape corresponding to the horizontal cross-sectional shape of the internal side surface 208-2 of the second bolt 204-2 is used to turn down the second bolt 204-2 to a second predetermined position to fix the position of the first bolt 204-1. However, there are instances where the second bolt 204-2 is turned down lower than the predetermined second position, resulting in turning down the first bolt 204-1 lower than the predetermined first position. In other words, the two bolts are turned together due, for example, to the friction between the two bolts, behaving like a single bolt pressing the part below the first bolt 204-1,

FIG. 3 illustrates an expanded view of a portion of the press die set of FIG. 1, including the layers D-F and the top portion of the punch 104 including the head 108, the conrod 112, the spacer 116 and the double bolt 120 having the conventional double-bolt structure 200 of FIG. 2, for example, The downward pressure exerted by the lowered double bolt 120 as mentioned above can be transmitted to the spacer 116 and then to the conrod 112, as represented schematically by arrow 350. As mentioned earlier, the gap width between the conrod 112 and the inner surface of the hole formed in the layer E may be relatively large, for example, about 0.5 mm, for adjustment and replacement of the conrod 112. Since there is very little force holding tightly the conrod 112 in the layer E, the conrod 112 tends to lower its position due to the downward pressure from the spacer 116, thereby pressing down the head 108 and the surrounding portion of the layer D. In general, the punch 104 including the head 108 is made of hardened steel having hardness greater than that of the layer D, i.e., the punch holder plate. As mentioned earlier, the gap width between the punch 104 including the head 108 and the inner surface of the penetration hole in the layer D may be set to be small, for example, about 0.005 mm. No matter how small the gap is, the lowered conrod 112 tends to press the portion of layer D surrounding the top portion of the punch 104 including the head 108, giving rise to bulging of the surrounding portion of the layer D into the gap, as indicated schematically by arrows 354. As a result, the punch 104 is held tightly in the layer D to such an extent that the punch 104 cannot be removed. This is problematic when the punch and/or other parts need to be replaced or accessed for maintenance or repairs.

As explained above, the downward pressure is caused by the double bolt that acts like a single bolt when the top bolt is turned and the bottom bolt also gets turned due, for example, to the friction between the two bolts. To alleviate the problem, a slip disk is devised and used to form a new type of a double-bolt unit according to an embodiment. The details of a new type of a double-bolt unit are explained below.

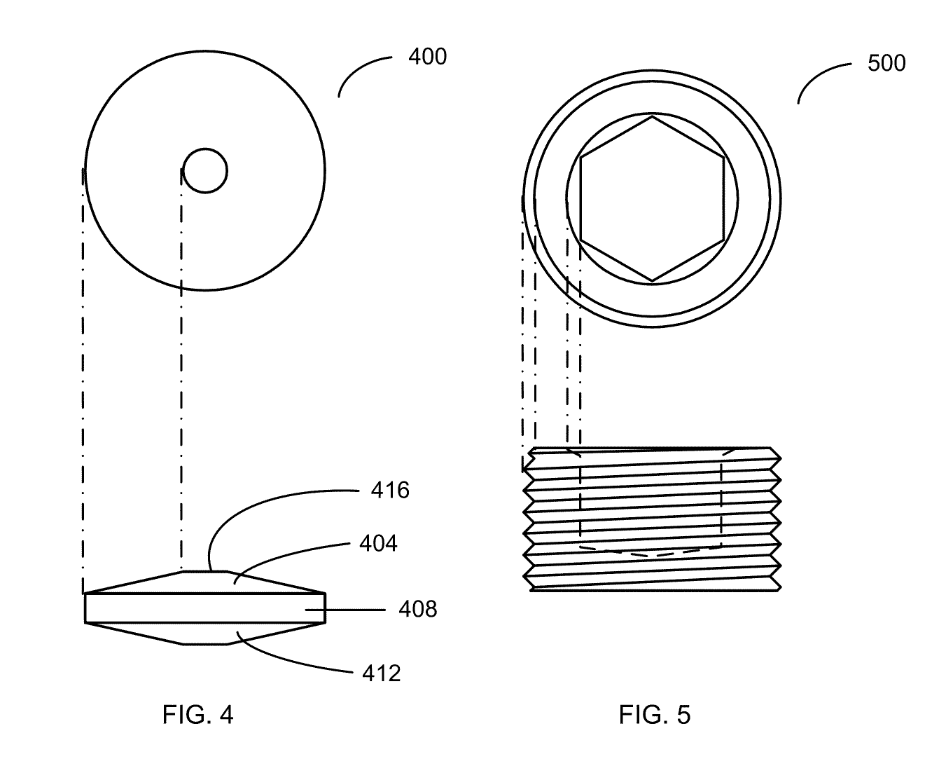

FIG. 4 illustrates an example of a slip disk 400 that can be included in the double-bolt unit, showing the top view and the side view. Correspondence between each element in the top view and in the side view is indicated by dash-dot line in this figure. The slip disk 400 has a shape of substantially a disk, having an upper section 404, a middle section 408 and a lower section 412. These three sections are formed concentrically in the horizontal direction and contiguously in the vertical direction, having the overall thickness larger at the center than at the peripheral of the disk. The middle section 408 has a shape of a cylinder with a first diameter, and the upper section 404 has substantially a convex shape with a flat top 416, which has a shape of a circle with a second diameter. Here, the first diameter of the cylinder, i.e., the middle section 408 is larger than the second diameter of the flat top 416 of the upper section 404 The shape of the lower section 412 may be made substantially the same as the upper section 404, providing the slip disk 400 with an overall symmetric shape in the vertical direction. In this case, the shape of the lower section 412 is of substantially a downward convex. The symmetric shape in the vertical direction avoids confusion to distinguish the top and the bottom when a worker needs to place the slip disk on another part.

FIG. 5 illustrates an example of a bolt 500 that can be included in the double-bolt unit, showing the top view and the side view. The bolt 500 may be a set screw having an external thread and a socket for wrenching drive. The opening of the socket is formed on the top surface of the bolt 500, and the socket is defined by the internal surface of the bolt 500. Correspondence between each element in the top view and in the side view is indicated by dash-dot line in this figure. A conventional bolt or a set screw, such as one of the double bolt 200 illustrated in FIG. 2, can be used for the present double-bolt unit. The horizontal cross-sectional shape of the socket, i.e., the horizontal cross-sectional shape of the internal side surface of the bolt 500, is hexagonal in this example; however, a shape of a star, a square, a rectangle or other polygonal shape can be used to form the horizontal cross-sectional shape of the internal side surface of the bolt 500. The vertical cross-sectional shape of the socket, i.e., the vertical cross-sectional shape of the internal surface of the bolt 500, is indicated by dashed line in this figure.

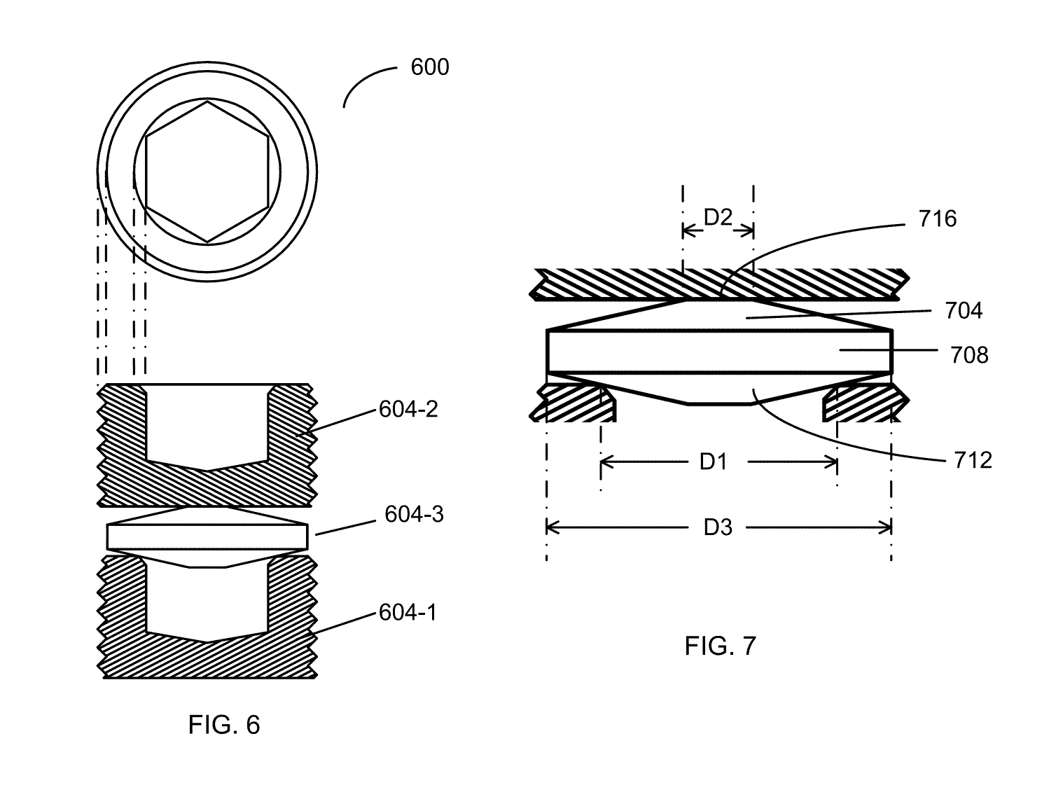

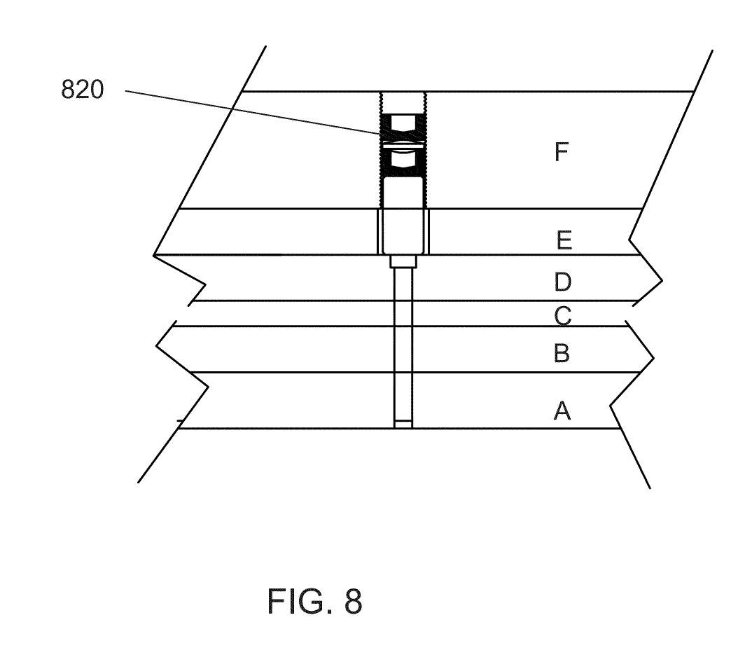

FIG. 6 illustrates a double-bolt unit 600 according to an embodiment, showing the top view and the vertical cross-sectional view. Correspondence between each element in the top view and in the vertical cross-sectional view is indicated by dash-dot line in this figure. The double-bolt unit 600 includes a first bolt 604-1 and a second bolt-2, each of which can be a conventional bolt or a set screw having an external thread and an internal socket for wrenching drive, as illustrated, in FIG. 5. The present double-bolt unit. further includes a slip disk 604-3, as illustrated in FIG. 4, which is placed on top of the first bolt 604-1 and below the second bolt 604-2, and concentrically therewith around the cylindrical axis.

FIG. 7 illustrates an expanded side view of the double-bolt unit 600 of FIG. 6, where the slip disk 604-3, the top portion of the first bolt 604-1 and the bottom portion of the second bolt 604-2 are shown. As explained with reference to FIG. 4, the slip disk 604-3 has the upper section 704, the middle section 708 and the lower section 712 in this example. These three sections are formed concentrically in the horizontal direction and contiguously in the vertical direction, having the overall thickness larger at the center than at the peripheral of the disk. The middle section 708 has a shape of a cylinder with a third diameter D3, and the upper section 704 has substantially a convex shape with a flat top 716, which has a shape of a circle with a second diameter D2. The fiat top 716 of the upper section 704 is in contact with the bottom surface of the second bolt 604-2. The shape of the lower section 712 may be made substantially the same as the upper section 704, providing the slip disk 604-3 with an overall symmetric shape in the vertical direction. The shape of the lower section 712 is of substantially a downward convex. The convex degree can be configured so that the lower section 712 sits on top of the first bolt 604-1 with the thick portion around the center of the convex shape protruding into the socket, As a result, a ring portion of the bottom surface of the lower section 712 is in contact with the inner edge portion at the top of the first bolt 604-1 where the opening of the socket is formed. The diameter of the ring portion of the bottom surface of the lower section 712, which is in contact with the inner edge portion at the top of the first bolt 604-1, is indicated with DI in this figure,

In the conventional double-bolt structure such as illustrated in FIGS. 2 and 3, when the second bolt 204-2 is turned down to fix the position of the first bolt 204-1, it is often the case that the first bolt 204-1 and the second bolt 204-2 move together like a single bolt due, for example, to the friction between the two bolts, resulting, in turning down the first bolt lower than the predetermined position, in contrast, the new type of a double-bolt unit, according to the embodiment, includes a slip disk between the two bolts, as illustrated in FIGS. 6 and 7. The diameter D3 of the middle section 708 may be determined to be smaller than the diameter of the bolts so that the slip disk 604-3 does interfere with the inner side surface of the threaded hole for the bolts. The convex degree of the lower section 712 may be configured so that the diameter Di is larger than the diameter D2, Loosely speaking, torque, moment or moment of force is a measure of force to rotate an object about an axis, and is expressed as rxF, where F is the force, r is the distance from the axis to the point where the force is applied, and x denotes the cross product, Therefore, given the same force F, the larger the r is, the larger the torque, In the process of assembling the double-bolt unit for a punching tool, the first bolt 604-1 is wrenched down to secure the part below, such as the spacer 116 of FIGS. 1 and 3. Second, the slip disk 604-3 is placed on top of the first bolt 604-1. Third, the second bolt 604-2 is placed on top of the slip disk 604-3 and wrenched down to fix the position of the first bolt 604-1. Under the condition of D2<D1, the D2-related torque that is required to turn the slip disk 604-3 with the second bolt 604-2 is smaller than the D1-related torque that is required to turn the slip disk 604-3 with the first bolt 604-1, Thus, when the bottom of the second bolt 604-2 is in contact with the fiat top 716 of the slip disk 604-3 and the D2-related torque is applied stronger than a threshold, the D2-related torque overcomes the frictional force between the flat top 716 and the portion of bottom surface of the second bolt 604-2 where the flat top 716 is in contact with. As a result, the second bolt 604-2 starts slipping on the flat surface 716, while the slip disk 604-3 is fixed stably on the first bolt 604-1 without turning down the first bolt 604-1. Therefore, by configuring Di and D2 to be D2<D1, the second bolt 604-2 starts slipping on the flat surface 716 at a certain torque strength while the slip disk 604-3 is fixed stably on the first bolt 604-1, thereby preventing lowering of the first bolt 604-1 below the predetermined position. In other words, DI and D2 can be configured so that when the first bolt 604-1 is positioned at the predetermined position and the second bolt 604-2 is turned, the second bolt 604-2 slips on the slip disk 604-3 while the slip disk 604-3 is fixed stably on the first bolt 604-1, thereby preventing the lowering of the first bolt 604-1 below the predetermined position.

The double-bolt unit haying a slip disk according to the embodiment can be used for a wide variety of applications, in particular, where a top bolt or a set screw is used to secure the position of a bottom bolt or a set screw. FIG, 8 illustrates a press die set in which the punching tool is configured to include the double-bolt unit 820 having a slip disk, such as illustrated in FIGS. 6 and 7, in place of the conventional double bolt, such as illustrated in FIGS. 2 and 3. As explained with reference to FIGS. 1 and 3, the downward pressure is caused by the conventional double-bolt structure that acts like a single bolt when the top bolt is turned down and the bottom bolt also gets turned down due, for example, to the friction between the two bolts. The conrod 112 tends to lower its position due to the downward pressure transmitted from the lowered double bolt to the spacer 116. The lowered conrod 112 tends to press the head 108 and the portion of layer D surrounding the top portion of the punch 104 including the head 108, giving rise to bulging of the surrounding portion of the layer D into the gap between the punch 104 including the head portion 108 and the inner surface of the hole in the layer D where the punch 104 is inserted. As a result, the punch 104 is held tightly in the layer D due to the bulging to such an extent that the punch 104 cannot be removed. In contrast, in the punching tool having the double-bolt unit including the slip disk, the lowering of the bolts is prevented by virtue of the slip disk based on the mechanism explained with reference to FIG. 7. Thus, the bulging of the portion of the layer D surrounding the top portion of the punch 104 including the head 108 is prevented, and the punch 104 can be detached from the rest of the structure freely for replacement and/or maintenance.

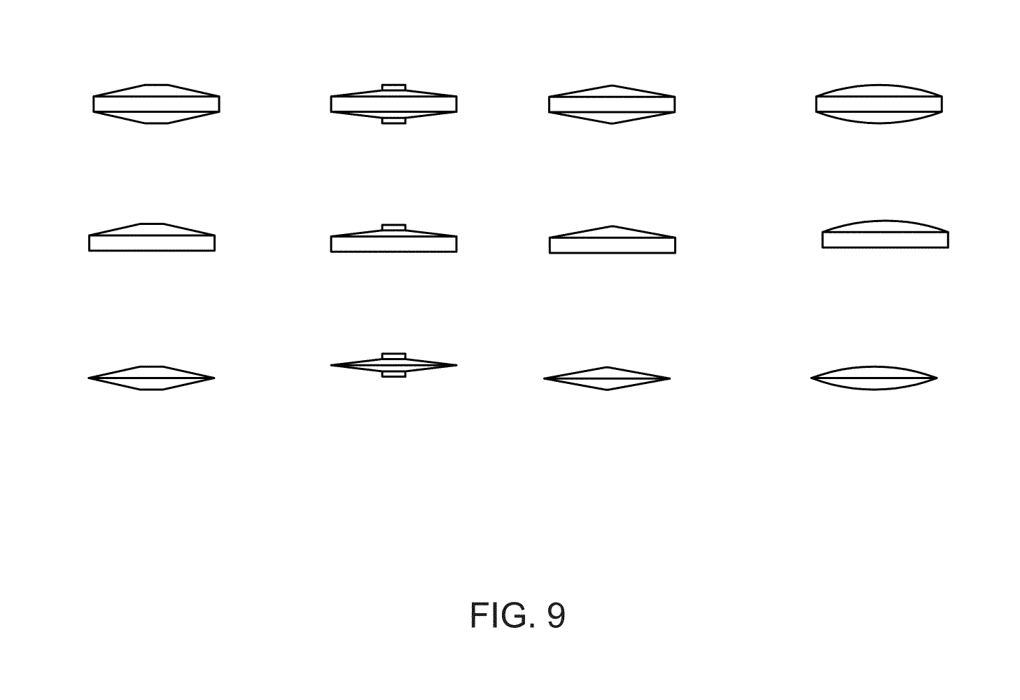

In the above examples, the slip disk used in the double-bolt unit has a shape of substantially a disk that is vertically symmetric and has a flat circular portion formed at the top of each convex, as illustrated in FIG. 4. However, various other shapes for the slip disk can be devised. As explained with reference to FIG. 7, the mechanism to prevent the lowing of the first bolt, which is generally caused by the turning down of the first and second bolts together more than necessary, involves two different torques related to two different diameters D1 and D2. The desired mechanism can be achieved by designing the shape of the slip disk so that the diameter D2 of the top surface of the slip disk that gets in contact with the portion of the bottom surface of the second bolt is smaller than the diameter DI of the ring portion on the bottom surface of the slip disk that gets in contact with the inner edge portion of the opening, of the socket at the top of the first bolt. FIG. 9 illustrates examples of shapes of the slip disk. The side view of each example is illustrated to show that each has substantially a disk shape and that the relationship D2<D1 is held. These shapes represent a few possible variations, and it should be understood that various other shapes are also possible to form the slip disk as long as D2<D1 is held.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A double-bolt unit comprising:
a first bolt;
a second bolt; and
a slip disk having substantially a disk shape, the slip disk placed on top of the fist bolt and below the second bolt and concentrically with the first: bolt and the second bolt around a cylindrical axis, the slip disk being configured to contact a portion of the first bolt and a portion of the second bolt, wherein a first radius from the cylindrical axis to the portion of the first bolt in contact with the slip disk is configured to be larger than a second radius from the cylindrical axis to the portion of the second bolt in contact with the slip disk to have a first torque related to the first radius for turning the slip disk with the first bolt is larger than a second torque related to the second radius for turning the slip disk with the second bolt.
wherein
when the first bolt is positioned at a predetermined position and the second bolt is turned, the second bolt slips on the slip disk while the slip disk is fixed stably on the first bolt, according to a difference between the first torque and the second torque, thereby preventing lowering of the first bolt below the predetermined position.

2. The double-bolt unit of claim 1, wherein
each of the first and second bolts has an external thread and a socket for wrenching drive, the socket defined by internal surfaces of the bolt and having an opening with an edge portion on a top surface of the bolt, and
the portion of the first bolt in contact with the slip disk is the edge portion.

3. The double-bolt unit of claim 1, wherein
the slip disk comprises a section that has a shape of substantially a convex, a top portion of which is in contact with the portion of the second bolt.

4. The double-bolt unit of claim 3, wherein
the top portion of the convex is shaped to be flat, rounded or pointed.

5. The double-bolt unit of claim 1, wherein
the slip disk has a symmetric shape in a vertical direction that is along the cylindrical axis.

6. A punching tool in a press die set, the punching tool comprising:
a punch to create a hole in a work piece by punching action; and
a double-bolt unit coupled to the punch;
wherein the double-bolt unit comprises:
a first bolt;
a second bolt; and
a slip disk having substantially a disk shape, the slip disk placed on top of the first bolt and below the second bolt and concentrically with the first bolt and the second bolt around a cylindrical axis, the slip disk being configured to contact a portion of the first bolt and a portion of the second bolt, wherein a first radius from the cylindrical axis to the portion of the first bolt in contact with the slip disk is configured to be larger than a second radius from the cylindrical axis to the portion of the second bolt in contact with the slip disk to have a first torque related to the first radius for turning the slip disk with the first bolt is larger than a second torque related to the second radius for turning the slip disk with the second bolt,
wherein
when the first bolt is positioned at a predetermined position and the second bolt is turned, the second bolt slips on the slip disk while the slip disk is fixed stably on the first bolt, according to a difference between the first torque and the second torque, thereby preventing lowering of the first bolt below the predetermined position.

7. The punching tool of claim 6, further comprising:
one or more puts between the punch and the double-bolt unit.

8. The punching tool of claim 6, wherein
the prevention of lowering of the first bolt below the predetermined threshold prevents a portion of a punch holder layer from bulging to hold the punch tightly, the portion surrounding a top portion of the punch.
